(19) United States
(12) Patent Application Publication
(10) Pub. No.: US 2014/0226204 A1
(43) Pub. Date: Aug. 14, 2014

(54) Optical Assembly and Light Microscope

(71) Applicant: CARL ZEISS MICROSCOPY GMBH, JENA (DE)

(72) Inventors: Reiner Mitzkus, Goettingen (DE); Heino Heise, Adelebsen (DE); Peter Westphal, Jena (DE); Christoph Windolph, Goettingen (DE)

(73) Assignee: CARL ZEISS MICROSCOPY GMBH, JENA (DE)

(21) Appl. No.: 14/177,339

(22) Filed: Feb. 11, 2014

(30) Foreign Application Priority Data
Feb. 11, 2013 (DE) 102013002423.4

(51) Int. Cl. G02B 21/06; G02B 5/20

(52) U.S. Cl. CPC G02B 21/06; G02B 5/201
USPC 359/388; 359/862

(57) ABSTRACT

The invention relates to an optical assembly for spectral filtration of light, having a plurality of filters which are permeable to light of different spectral ranges, a filter selection mirror which can be moved for selectable deflection of light to different optical paths to the different filters, and an output mirror which can be moved to guide light coming from one of the filters to an optical path which is the same for all the filters. The optical assembly is characterized according to the invention in that in each case at least one stationary deflection optical system is provided for each of the optical paths to the different filters to guide light from the filter selection mirror to the respective filter and/or light from the respective filter to the output mirror, and the stationary deflection optical systems are arranged so that optical path lengths on the different optical paths from the filter selection mirror to the output mirror are equal. The invention further relates to a light microscope having an optical assembly according to the invention.

### TECHNICAL FIELD

The present invention relates in a first aspect to an optical assembly for spectral filtration of light.

According to a second aspect the invention relates to a light microscope.

### RELATED ART

A generic light microscope has a light source for illuminating a specimen. Light transmitted through the specimen can be detected in a transmitted light measurement. Alternatively or additionally, a specimen image can be recorded for example with luminescent light of the specimen, that is to say fluorescent or phosphorescent light.

A spectral filtration of the light produced is often to take place in these as well as in further microscopy methods. Filtration can thereby be provided both for the illuminating light guided onto the specimen and for the specimen light coming from the specimen. It is to be possible to switch between different spectral ranges as quickly as possible, for example within 1 to 50 ms.

It is widespread practice to use rotatable filter wheels for spectral filtration. A plurality of filters are arranged on such rotatable filter wheels, whereby each one of these filters can be brought into an optical path by rotating the filter wheel. This is used in particular for imaging optical paths with beam cross-sections of over 5 mm. The achievable switchover times between different filters are, however, comparatively high and can be between 30 and 100 ms. In addition, upon rotation, filter wheels produce a large angular momentum due to their great mass and expanse, whereby this angular momentum can lead to undesirable vibrations. It is necessary to wait until these vibrations have subsided before recording an image. A measurement interruption time can thereby increase further when switching between different filters.

More rapid switching can indeed be achieved with acousto-optical filters instead of a filter wheel. However, only comparatively small beam cross-sections can hereby be used.

DE 10 2010 045 856 A1 further discloses guiding light coming from the specimen with a scanning mirror selectively to one of a plurality of filters. Behind the filters the course of the light depends upon the selected filter. The position of the specimen image produced on a camera chip is thus dependent upon the selected filter. Optical systems behind the filters and also the camera chip must thus be selected to be comparatively large.

Rapid switchover can additionally be achieved with a generic optical assembly for spectral filtration of light. Such an optical assembly has a plurality of filters which are permeable to light of different spectral ranges, a filter selection mirror which can be moved for selectable deflection of light to different optical paths to the different filters, and an output mirror which can be moved for guiding light coming from one of the filters to an optical path which is identical for all the filters.

As a result of the different optical paths, however, imaging differences can arise when switching between different filters.

### SUMMARY OF THE INVENTION

The present invention provides an optical assembly and a light microscope with cost-effective means, wherein it is possible to switch as rapidly as possible between measurements of different spectral ranges while ensuring mechanical vibration which is as low as possible and image quality which is as high as possible.

It is provided according to the invention in the case of the optical assembly of the abovementioned type that at least one stationary deflection optical system for guiding light from the filter selection mirror to the respective filter and/or light from the respective filter to the output mirror is present for each of the optical paths to the different filters. It is also provided that the stationary deflection optical systems are arranged so that optical path lengths on the different optical paths from the filter selection mirror to the output mirror are equal.

In the case of a light microscope of the abovementioned type it is provided according to the invention that an optical assembly according to the invention is present for the spectral filtration of light coming from the specimen.

According to the invention, imaging differences between different optical paths can be reduced if, as a result of the arrangement of the stationary deflection optical systems, the optical path lengths on different optical paths are equal. The optical path lengths for each of the optical paths to the filters are thereby preferably equal. Optical path lengths, or light travelling paths, can be understood to mean the geometric sections, along which light can be guided from the filter selection mirror to the output mirror, multiplied by the refractive indexes of the respective sections. The optical path length for a certain optical path is thus determined by integrating the location-dependent refractive index over the section of this optical path.

In the case of different optical path lengths for the different selectable optical paths, a change in the selected optical path would lead to a change in the image of the specimen on a camera, the specimen being arranged in the optical path behind the camera. As a result of this change a specimen point would be imaged on different pixels of the camera in dependence upon the selected optical path. Equal optical path lengths can be understood to mean conformity to the effect that a specimen point is imaged on the same pixels of a camera, which can be positioned in an image plane behind the output mirror, independently of the selected optical path. In other words, the optical path lengths are to be equal within a tolerance length. The tolerance length is thereby defined in that a change in the optical path length of one of the optical paths by the tolerance length would merely lead to a displacement of the imaging of a specimen point on the camera which is smaller than a pixel pitch of the camera. Alternatively, the tolerance length can be defined via a displacement of the imaging of a specimen point which is at least smaller than a triple, preferably double, pixel pitch. Equal optical path lengths can thus be defined via a camera resolution.

According to the invention, the different optical paths to the filters are not formed with shared stationary deflection optical systems but instead with at least one stationary deflection optical system in each case. The stationary deflection optical systems can thereby be positioned independently of each other so that equal optical path lengths can be achieved in a relatively simple manner. For example, mirrors or also deflection prisms can be used as deflection optical systems.

Electronic control means can usefully be present and be adapted, for the selection of a certain optical path to one of the filters, to simultaneously rotate the filter selection mirror and the output mirror. These mirror rotations can be realized within a few milliseconds if piezoelectric actuators, a galvanometer or another motor are present for adjusting the filter selection mirror and the output mirror. The two mirrors can each be formed by a respective mirror surface or can also each comprise a mirror array, of which the individual mirrors are designed for example as switchable MEMS (microelectromechanical systems). In principle, each deflection optical system can also comprise two or more mirror surfaces which meet each other in the form of a roof edge.

In an embodiment of the optical assembly according to the invention an input optical system, for example a lens system, is present in the optical path in front of the filter selection mirror for guiding incident light as a parallel beam bundle to the filter selection mirror. The input optical system thus produces an imaging at infinity. The filter selection mirror, the stationary deflection optical systems, the filters and the output mirror are arranged in the infinite space hereby produced. The effects of slight remaining differences in the optical path lengths of the different optical paths to different filters, which can in practice never be completely avoided, can hereby be advantageously reduced.

In the shared optical path behind the output mirror an output optical system can usefully be present, with which the parallel beam bundle is imaged in an intermediate image plane, in which a camera can be arranged. In order to ensure that the light also reaches the output optical system as a parallel beam bundle, the filter selection mirror, the output mirror, the filters and/or the deflection optical systems may each have a planar light contact surface.

In a variant of the optical assembly according to the invention, precisely one stationary deflection optical system is arranged in each of the optical paths to different filters. An unavoidable positioning imprecision is associated with each stationary deflection optical system. If only one deflection optical system, instead of a plurality of deflection optical systems, is used for each optical path, aberrations or deviations between different optical paths are comparatively small. In addition, in order to reduce imaging differences between the different optical paths, the deflection optical systems can be arranged so that the optical path lengths from the filter selection mirror to the deflection optical systems are equal.

Different filters lead, even with equal thickness, to different optical path lengths if the refractive indexes thereof are different. In order that the optical path lengths for the selectable optical paths are nonetheless equal, the absolute distances of the different optical paths can be different from each other.

According to an embodiment, a first and a second stationary deflection optical system are arranged in each of the optical paths to different filters, wherein light can be guided from the filter selection mirror via one of the first deflection optical systems to the associated filter and further via the associated second deflection optical system to the output mirror. In contrast with the configuration having only one deflection optical system for each optical path, it is possible here for the filter selection mirror and the output mirror to be arranged so that light contacts the two mirrors at smaller angles to a surface normal. The two mirrors can thereby be selected to be smaller. As a consequence, shorter switching times of the two mirrors are possible.

The filter selection mirror and the output mirror may be mounted to be rotatable around a common rotation axis which may be positioned in or parallel to an optical axis of light passing to the filter selection mirror. When changing between the optical paths to different filters, the filter selection mirror and the output mirror are rotated here by a coinciding angle in the same direction. An embodiment is hereby made possible, in which the filter selection mirror and the output mirror are rigidly connected to each other. A common drive shaft can thereby be present to rotate both the filter selection mirror and the output mirror. Undesirable positioning differences between the two mirrors are hereby advantageously avoided. In addition a simultaneous adjustment of the two mirrors in a mechanically cost-effective way is ensured, whereby the number of components required is small.

Insofar as the rotation axis is positioned in or parallel to the optical axis of light passing to the filter selection mirror, the angle between incident and reflected light on the filter selection mirror for the different rotation positions of the filter selection mirror is equal. The same applies correspondingly to the output mirror. Angle-dependent effects of reflections on the mirrors do not therefore lead to any undesirable differences between the different optical paths.

In this configuration, the different optical paths can thus be selected in that incident light is deflected at different azimuthal angles but at a constantly equal polar angle. These angles are to be understood by reference to the propagation direction of light passing to the filter selection mirror. The closer the selected polar angle is to 180°, the smaller is an angle between the incident light and the surface normal of the mirror surface of the filter selection mirror or of the output mirror. The filter selection mirror and the output mirror can thereby be selected to be particularly small, whereby shorter switchover times are associated therewith. The filter selection mirror and the output mirror may be arranged so that the polar angle, by which light is deflected, is greater than 40°, preferably greater than 80°, and particularly preferably greater than 120°.

A mechanically comparatively simple securing of the filters can be achieved through the presence of a filter holder to hold the filters in a plane extending perpendicular to the common drive shaft of the filter selection mirror and the output mirror. The filters thereby extend within this plane, that is to say a surface normal of the filters is perpendicular to said plane. Precise positioning of all filters can thereby be cost-effectively achieved with a filter holder.

In order to facilitate simple exchange of a plurality of filters, the filter holder can also have a plurality of detachable holder elements, each holding a few of the filters provided.

The filter holder can have an opening in the middle, through which the drive shaft of the filter selection mirror and the output mirror extends. At the same time as limited space requirement, a high stability of the filter holder is hereby achieved.

In a further embodiment of the optical assembly according to the invention the filter selection mirror and the output mirror are mounted to be rotatable around rotation axes differing from each other. The rotation axes of the filter selection mirror and of the output mirror are thereby respectively transverse, in particular perpendicular, to a propagation direction of light passing to the filter selection mirror. In order to change between the optical paths to different filters, according to this configuration the filter selection mirror and the output mirror are rotated by equal angles in opposite directions. By rotating them in opposite directions, the resulting torques that could undesirably set the components of the optical assembly into vibration are partially compensated.

A polar angle, by which light is deflected on the filter selection mirror and on the output mirror, is different here for the different optical paths. The polar angle for all optical paths is preferably greater than 90°, particularly preferably greater than 120°. The filter selection mirror and the output mirror can hereby be designed to be particularly small. This advantageously facilitates more rapid switching between different rotation positions.

Galvanometer scanners for rotating the mirrors are particularly suited for this relatively small rotation range of the two mirrors. The maximum possible rotation range of galvanometer scanners is generally comparatively small. As a result, the switching duration of galvanometer scanners is very short and can lie for example in the range of a few milliseconds.

The arrangement of the filters relative to the filter selection mirror and to the output mirror is co-determinant for the length of the optical paths. In order to provide equal optical path lengths on the different optical paths the filters may be arranged mirror-symmetrically or rotation-symmetrically to a connecting straight line between a central region of the filter selection mirror and a central region of the output mirror. In the case of rotational symmetry, for example, the filters can be positioned around the circumference of a circle, the mid-point of the circle lying on the connecting straight light. In the case of mirror symmetry the filters can be arranged along a straight line which perpendicularly intersects the connecting straight line.

A particularly large number of selectable spectral ranges are facilitated if there are additional filters for selecting further spectral ranges and motorized filter changers are provided and adapted to move a respective one of the additional filters into one of the optical paths to one of the filters and to move it out again. The motorized filter changers may be adapted to move a respective one of the filters out of the associated optical path if one of the additional filters is moved into this optical path. In order to ensure that the space requirement of the filters and the additional filters is low in a direction transverse to the propagation direction of the incident light, a respective one of the filters and an associated additional filter can be arranged offset along the corresponding optical path.

A change may be made between a filter and the associated additional filter while image recording is realized with another filter or additional filter. Measurement interruption times are hereby kept low.

In principle, in addition to the filters and additional filters, further filter planes can also be present which can be moved, instead of or in addition to the filters and additional filters, into the selectable optical paths.

In order to be able to select a large number of different spectral ranges, at least one of the filters can also be a graduated filter, over the length of which a spectral transmission range changes. Electronic control means can hereby be present and be adapted to move the graduated filter in order to select a certain spectral transmission range of the graduated filter. The length of the graduated filter can usefully be greater than a length of the remaining filters, in particular at least double or triple the size thereof. A more precise wavelength selection with the graduated filter is facilitated if it has a curved shape. This curvature can extend in the circumferential direction around the common rotation axis of the filter selection mirror and the output mirror. It is hereby made possible for a plurality of optical paths to different regions of the graduated filter to be selectable via the stationary deflection optical systems.

Greater flexibility can be provided if a plurality of the filters are graduated filters. Electronic control means can hereby be present and be adapted to respectively record two consecutive specimen images with different graduated filters and, for reduction of a measurement interruption time, to move one of the graduated filters while specimen image recording is realized with one of the other graduated filters.

The optical assembly can usefully have at least one camera to measure the light which is arranged in the optical path behind the output mirror. In order to reduce a measurement interruption time, electronic control means can be present and be adapted to carry out an adjustment of the filter selection mirror and the output mirror during a readout time of the at least one camera in order to change between the different optical paths to the different filters. A measurement interruption time can thus be determined by a switching duration of the two mirrors and not be dependent upon the readout time of the camera.

Particularly if the readout time of the camera is greater than a switching duration of the two mirrors, a further reduction in the measurement interruption time can be reached with an optical assembly having a plurality of cameras arranged in the optical path behind the output mirror. At least one color splitter is provided between the output mirror and the cameras, with which color splitter the light can be further guided to one of the cameras depending upon the wavelength. Electronic control means are provided and are adapted, for the purpose of recording a plurality of specimen images with light of different spectral ranges, to adjust the filter selection mirror and the output mirror for sequential selection of different filters and, for reduction of a measurement interruption time, to respectively select filters consecutively, with which the light is guided, on the basis of the transmission ranges of these filters on the color splitter to different cameras. A threshold wavelength of the color splitter between transmission and reflection can be selected so that light from the different filters on the color splitter is either completely reflected or completely transmitted.

The optical assembly according to the invention is suited for the implementation of a method to determine an imaging offset between the different optical paths to the filters. The imaging offset can lie in particular transverse to the propagation direction of the light. It is provided according to the method that, in each case, an image of a reference object is recorded with each of the optical paths, that conversion parameters for the different optical paths are determined by means of the position and the size of the reference object within the images and, using these conversion parameters, the images can be converted so that the size and position of the reference object within a processed image are independent of the selected optical path to one of the filters, and that in a measurement operation a specimen image is converted with the conversion parameters in dependence upon the selected optical path. The optical assembly can also comprise electronic control means adapted to automatically record the different images of the reference object, to determine the conversion parameters and to convert a specimen image recorded in the measurement operation with the conversion parameters. The reference object can for example be a dot matrix or a grating.

A further method can be carried out with the optical assembly according to the invention if the filters and/or additional filters comprise at least a first and a second group of filters, wherein the transmission ranges of the filters of the first group have a broader bandwidth than the transmission ranges of the filters of the second group. The method comprises at least the following steps: specimen images are recorded with a plurality of filters of the first group; a spectral range of interest is determined which is smaller than a spectral range examined with the filters of the first group; and specimen images are recorded with different filters of the second group, of which the transmission ranges lie within the spectral range of interest. Using the first group of filters therefore a spectrum with a low wavelength resolution can be recorded in a short time period. Depending upon the specimen, only a comparatively narrow spectral range is generally of interest. This can be examined with higher spectral resolution by the filters of the second group. Electronic control means may be present and are adapted to automatically carry out the method. The spectral range of interest can thereby be determined by a user or automatically in dependence upon the measured light intensity and/or the change in the light intensity over the wavelength.

In the case of the light microscope according to the invention the optical assembly can be arranged in principle in the illuminating optical path, that is to say between the light source and the specimen. The significant advantage of reducing aberrations through equal optical path lengths on the different optical paths of the different filters is particularly great, however, if the optical assembly is arranged in the detection optical path, thus in the optical path behind the specimen.

The light microscope may include imaging means to produce an imaging of the specimen in an intermediate image plane, and the input optical system of the optical assembly may be arranged so that it produces an imaging of this intermediate image plane at infinity. Light thereby passes from the input optical system as a parallel beam bundle via the filter selection mirror, a selected filter and the output mirror as far as an output optical system. Effects of negligible differences in optical path lengths on the different optical paths can thereby be further reduced.

Flexible possibilities of use are provided if the imaging means produce the intermediate image plane on a camera output of the light microscope. The optical assembly can have connection means, through which it can be detachably connected to the camera output.

### BRIEF DESCRIPTION OF THE DRAWINGS

Further advantages and features of the invention are described below by reference to the attached schematic figures.

FIG. 1 shows a schematic representation of a first exemplary embodiment of a light microscope according to the invention having an optical assembly according to the invention.

FIG. 2 shows a schematic top view of an optical assembly according to the invention.

FIG. 3 shows a schematic top view of a further exemplary embodiment of an optical assembly according to the invention.

FIG. 4 shows a schematic top view, in turn, of a further exemplary embodiment of an optical assembly according to the invention with a graduated filter.

FIG. 5 shows a schematic representation of a second exemplary embodiment of a light microscope according to the invention having an optical assembly according to the invention.

FIG. 6 shows a schematic representation of a third exemplary embodiment of a light microscope according to the invention having an optical assembly according to the invention.

FIG. 7 shows a top view of a fourth exemplary embodiment of a light microscope according to the invention having an optical assembly according to the invention.

FIG. 8 shows a side view for the exemplary embodiment of FIG. 7.

FIG. 9 shows a side view of a fifth exemplary embodiment of a light microscope according to the invention having an optical assembly according to the invention.

Identical components and components working identically are generally identified in the figures by the same reference symbols.

### DETAILED DESCRIPTION OF THE INVENTION

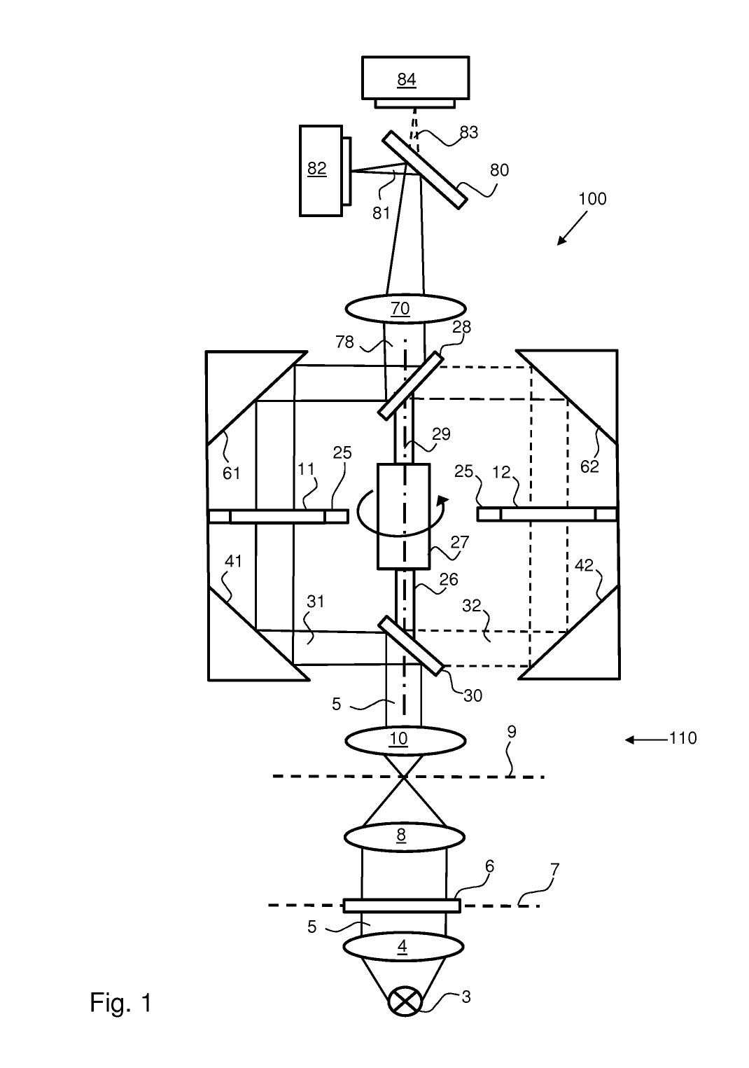

FIG. 1 shows schematically a first exemplary embodiment of a light microscope 110 according to the invention having an optical assembly 100 according to the invention. Said optical assembly 100 is arranged in the optical path of the light microscope 110 behind a specimen 6 and serves for selectable spectral filtration of the light to be detected. It comprises at least one camera 82, 84 to detect the filtered light.

The light microscope 110 has a light source 3 which can comprise for example one or more lasers. It can also comprise one or more broadband light sources which can emit in particular light of the whole visible, ultraviolet and/or infrared spectral range.

In the optical path behind the light source 3, imaging means 4 are provided, with which light 5 emitted by the light source 3 is guided to a specimen plane 7. A specimen 6 can be positioned there.

Light 5 coming from the specimen 6 is to be detected. This can be light 5 transmitted through the specimen 6 or also light 5 emitted by the specimen 6, in particular phosphorescent or fluorescent light.

The light 5 coming from the specimen 6 reaches further imaging means 8 which can for example comprise an objective. An imaging of the specimen 6 in an intermediate image plane 9 is hereby produced. The intermediate image plane 9 can lie in the range of a camera output of the light microscope 110.

The optical assembly 100 may include a housing, on which mechanical connecting means are present for connection to the camera output.

Within the housing, the optical assembly 100 has the components used for spectral filtration of the light. These are described in greater detail below and comprise at least an input optical system 10, a filter selection mirror 30, stationary deflection optical systems 41, 42, 61, 62, an output mirror 28 and an output optical system 70.

The position and refractive power of the input optical system 10 are selected so that, when the optical assembly 100 is connected to the camera output of the light microscope 110, the input optical system 10 produces an imaging of the intermediate image plane 9 at infinity. The input optical system 10 thus guides light 5 from the specimen 6 as a parallel beam bundle.

The parallel beam bundle can be guided behind the input optical system 10 via different optical paths to different filters in order to finally reach an output optical system 70 on a shared optical path, with which output optical system 70 imaging of the specimen 6 on a camera takes place. The input optical system 10 thus produces an infinite space as far as the output optical system 70, in which infinite space the light 5 from the specimen 6 continues as a parallel beam bundle. The effects of different optical path lengths over the optical paths to different filters are hereby reduced. Such effects can relate to the position of the image produced with the output optical system 70 in the propagation direction of the light 5.

The optical assembly 100 has a plurality of filters 11, 12 which differ in their spectral transmission ranges. A selection of one of the filters 11, 12 takes place not by displacing the filter itself, but instead, according to the invention, the light 5 is selectively guided to a desired filter 11, 12. For this purpose the optical assembly 100 has a filter selection mirror 30. This can be adjusted to different rotation positions, through which the light 5 is guided to one of different optical paths 31, 32 and thus to one of the filters 11, 12. Very rapid switching between one of the optical paths 31, 32 can advantageously be achieved by the filter selection mirror 30. Such a switching duration can for example be 5 ms to 15 ms.

In order to guide light 5 from each of the optical paths 31, 32 to a common optical path 78 in the direction of the cameras 82, 84, the optical assembly 100 additionally has an output mirror 28 which can likewise be rotated. The optical path 31 is selected in the situation shown via the two mirrors 30, 28. By rotating the two mirrors by 180° the optical path 32 shown in dashes is selected.

The filter selection mirror 30 and the output mirror 28 are rotated jointly by an identical angle in the same direction. In the example shown, the two mirrors 30, 28 are rigidly connected to each other. They can hereby be rotated via a common drive shaft 26 by a motor 27 around a common rotation axis 29. The rotation axis 29 is in the optical axis of the light 5 passing from the input optical system 10 to the filter selection mirror 30. The rotation positions of the filter selection mirror 30 and the output mirror 28 are offset by 180° relative to each other. This construction advantageously ensures that only a single motor 27 is necessary. By rigidly connecting the two mirrors 30, 28, an undesirable time offset between the switching of the two mirrors is additionally excluded.

In order to guide the light 5 on the different optical paths 31, 32 to the associated filter 11, 12 and further to the output mirror 28, at least one deflection optical system 41, 42, 61, 62 is present in each of the optical paths 31, 32. In the example shown, two stationary deflection optical systems are arranged in each optical path. In a first optical path 31, light 5 is guided via a first deflection optical system 41 through a first filter 11. The light 5 then reaches a second deflection optical system 61, with which it is guided to the output mirror 28. Correspondingly, light 5 passes on a second optical path 32 from the filter selection mirror 30 to a first deflection optical system 42 of this optical path and, from there, further through a second filter 12 to a second deflection optical system 62 of this optical path and finally to the output mirror 28.

In the example shown, the deflection optical systems 41, 42, 61, 62 are constituted by mirrors. In principle, they can also be formed by deflection prisms or other optical deflection means.

The deflection optical systems 41, 42, 61, 62 are arranged so that light 5 passes on all optical paths 31, 32 between one of the first deflection optical systems 41, 42 and the associated second deflection optical system 61, 62 parallel to the rotation axis 29 of the two mirrors 30, 28. The filters 11, 12 can hereby be held by a filter holder 25 within a plane extending perpendicular to the rotation axis 29. A precise positioning of the filters 11, 12 with the filter holder 25 can thereby be realized in a mechanical simple way.

The light 5 filtered through the selected filter 11, 12 is guided with the output mirror 28 to an optical path 78 shared by all filters 11, 12. In this optical path 78 is the output optical system 70 which produces an imaging of the specimen 6 in a further intermediate image plane. Behind the output optical system 70 there is at least one color splitter 80 in the embodiment shown, with which color splitter 80 the light 5 is guided in dependence upon the selected filter 11, 12 either to an optical path 81 or to an optical path 83. A camera 82, 84 for recording a specimen image is arranged in each of these optical paths 81, 83 in the intermediate image plane.

If measurements are to be carried out with a plurality of filters, always such filters as these with which the light 5 is guided to different cameras 82, 84 due to the transmission ranges of these filters are selected, for example, consecutively. An effect of the readout time of the cameras 82, 84 upon a measurement interruption time between two subsequent measurements can thereby be reduced.

A rotation of the two mirrors 30, 28 to change a selected optical path 31, 32 may be realized simultaneously with the readout of one of the cameras 82, 84. The measurement interruption time is likewise thereby reduced.

The position of the image of the specimen 6 produced by the output optical system 70 is to be independent of the selection of one of the optical paths 31, 32. This is achieved in the optical assembly 100 according to the invention by the deflection optical systems 41, 42, 61, 62 being arranged so that the optical path lengths between the filter selection mirror 30 and the output mirror 28 are always equal, independently of the selected optical path 31, 32, in particular coinciding within a tolerance of 5% or 1%. It is advantageous for this purpose that the different optical paths 31, 32 are not formed by common deflection optical systems, but instead each has its own deflection optical system 41, 42, 61, 62. In order to provide equal optical path lengths, the deflection optical systems of different optical paths 31, 32 may be arranged rotationally symmetrically with respect to the rotation axis 29.

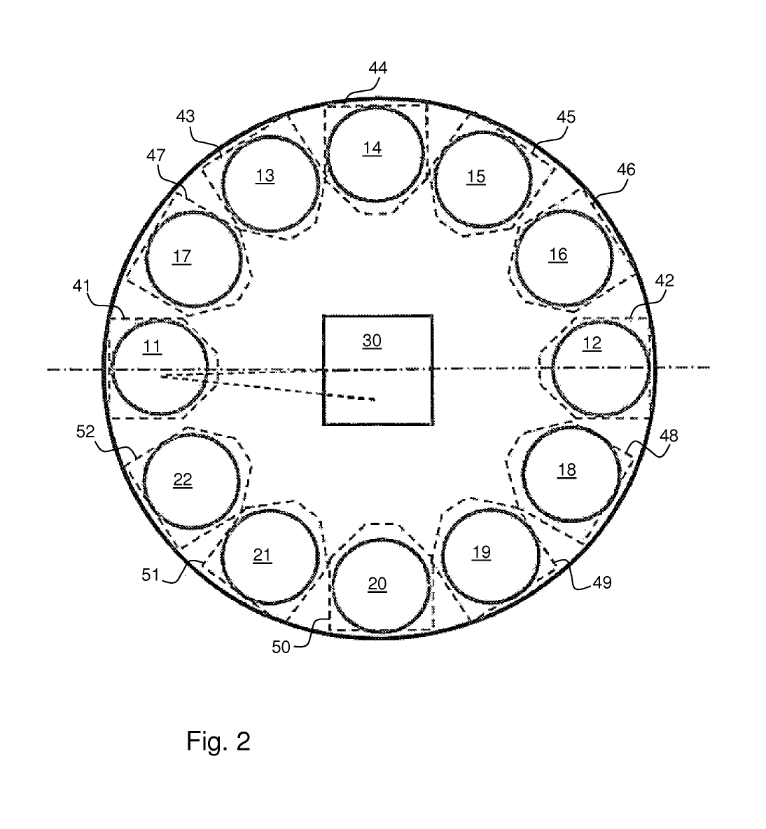

The selectable filters are consequently also arranged rotationally symmetrically around the rotation axis 29. It is hereby additionally possible to provide a number of selectable filters which is as large as possible. Such an arrangement of the filters is shown schematically in a top view in FIG. 2.

In FIG. 2, twelve filters 11 to 22 are arranged in a circle around the filter selection mirror 30. In addition, the first deflection optical systems 41 to 52 belonging to the filters 11 to 22 are shown in dashes.

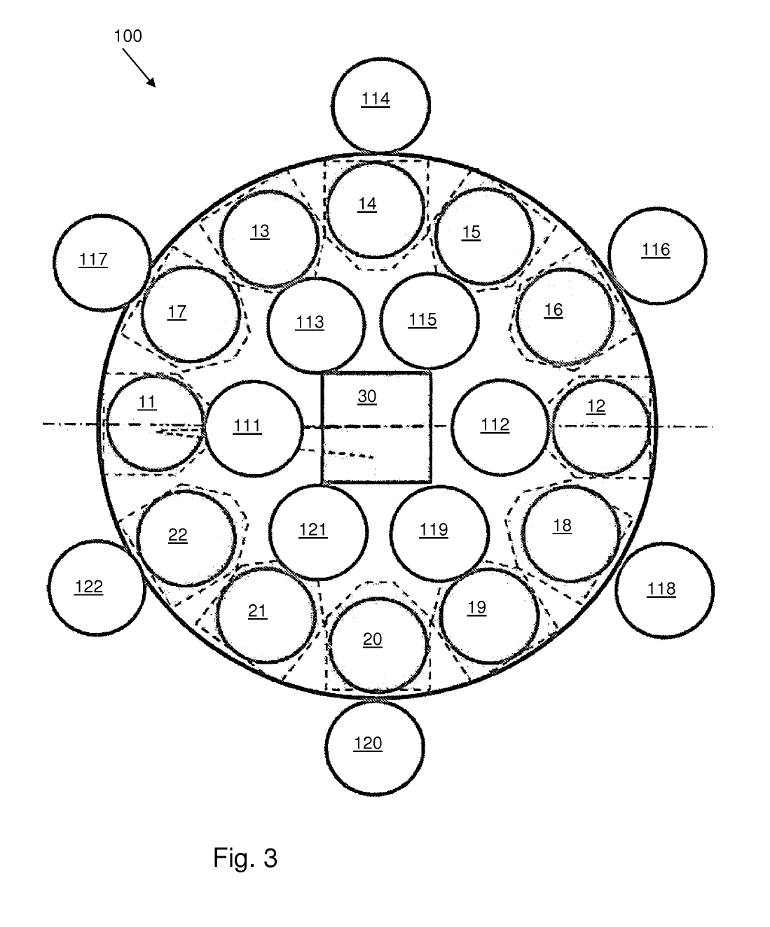

A configuration with an increased number of filters is shown in FIG. 3. This shows in turn a top view of an optical assembly 100 according to the invention. In addition to the filters 11 to 22 described with reference to FIG. 2, an additional filter 111 to 122 is hereby provided respectively besides the filters 11 to 22. In the arrangement shown the additional filters 111 to 122 are located outside of the optical paths which can be selected via the filter selection mirror 30. In order to move the additional filters 111 to 122 into the optical path of the respectively adjacent filter 11 to 22, motorized filter changers (not shown) are provided. These can also be adapted to move one of the filters 11 to 22 out of the corresponding optical path if one of the additional filters 111 to 122 is moved into this optical path. For a space-saving arrangement, the additional filters 111 to 122 can be offset relative to the filters 11 to 22 along the rotation axis of the filter selection mirror 30.

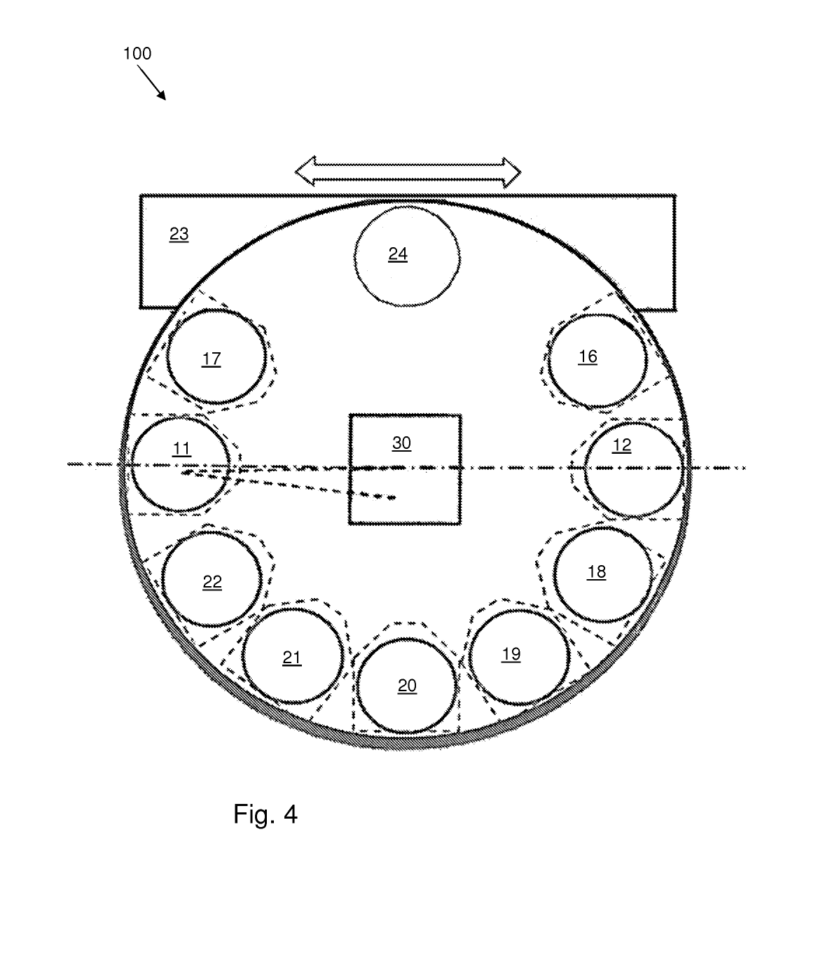

Alternatively or additionally to the additional filters 111 to 122, one of the filters can also be a graduated filter, of which the transmission range changes spectrally over its length. An optical assembly 100 with such a graduated filter 23 is shown schematically in FIG. 4 in a top view. The graduated filter 23 takes up the space of several filters. An optical path can be selected via the filter selection mirror 30, via which optical path only a proportion 24 of the graduated filter 23 is passed through. By means of drive means (not shown), electronic control means can displace the graduated filter 23 along the direction of the double arrow. A transmission range of the graduated filter 23 selected via the section 24 can advantageously hereby be changed in steps.

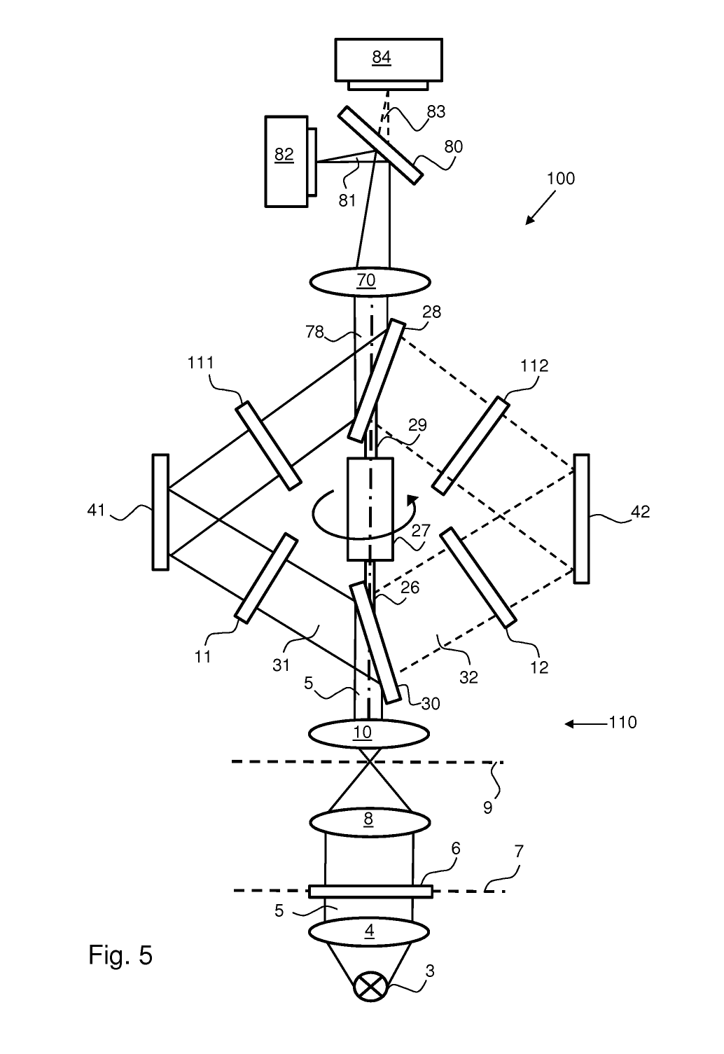

A second exemplary embodiment of a light microscope 110 according to the invention having an optical assembly 100 according to the invention is shown schematically in FIG. 5. Differences from the first exemplary embodiment of FIG. 1 lie in the arrangement of the filter selection mirror 30, the output mirror 28, the filters and additional filters 11, 12, 111, 112 and in the arrangement and number of the stationary deflection optical systems 41, 42.

In the exemplary embodiment of FIG. 5, each of the optical paths 31, 32 is formed with precisely one stationary deflection optical system 41, 42. Through this small number of deflection optical systems 41, 42 for each optical path 31, 32, inaccuracies in the beam guiding, caused by imprecise positioning of the deflection optical systems 41, 42, are reduced. As a result, in the configuration of FIG. 5 the requirements upon precision of the filter selection mirror 30 and the output mirror 28 are lower, whereby these can be moved more quickly.

The filters 11, 12 are arranged here between the filter selection mirror 30 and the deflection optical systems 41, 42. Alternatively, the filters 11, 12 can, however, also be positioned between the deflection optical systems 41, 42 and the output mirror 28. At these points, in the example shown, additional filters 111, 112 are provided, which can be brought into the optical paths instead of or in addition to the filters 11, 12.

The embodiment shown in FIG. 1 with a plurality of deflection optical systems for each optical path provides the advantage over the configuration of FIG. 5 that deflection angles of light 5 on the filter selection mirror 30 and on the output mirror 28 can be selected to be greater. A deflection of the incident light of approximately 90° takes place with the filter selection mirror 30 and the output mirror 28 of FIG. 1. In FIG. 5 this deflection is only 45°. In the case of a greater deflection angle, the cross-sectional areas of the two mirrors 30, 28 can be selected to be smaller. Shorter switching times of these mirrors 30, 28 are thus possible.

In order to further reduce the required dimensions of the two mirrors 30, 28 in relation to the example of FIG. 1, the two mirrors 30, 28 can be arranged so that the deflection angle is greater than 90° and lies for example between 100° and 150°. The inclinations of the first and second deflection optical systems may thereby be selected so that light continues to pass between one of the first deflection optical systems and the associated second deflection optical system parallel to the rotation axis 29 of the two mirrors 30, 28.

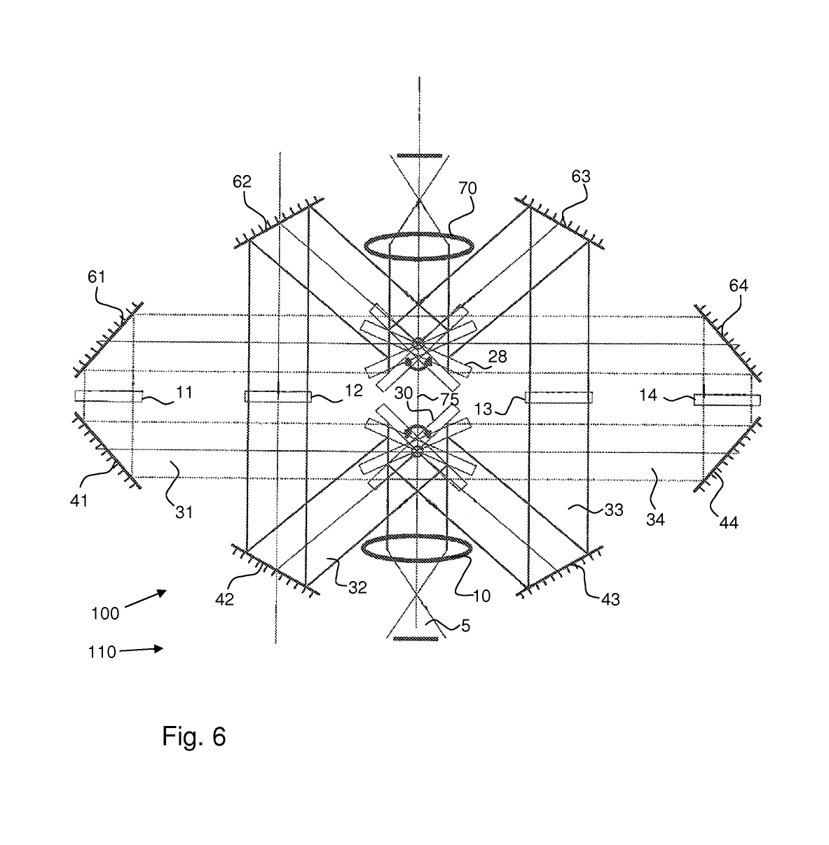

A third embodiment of a light microscope 110 according to the invention having an optical assembly 100 according to the invention is shown in FIG. 6. While the exemplary embodiments of FIGS. 1 and 5 offer the advantages of a common rotation of the filter selection mirror 30 and the output mirror 28 and a rigid connection of these mirrors 30, 28, in the variant of FIG. 6 the filter selection mirror 30 and the output mirror 28 are mounted so that they can rotate around rotation axes differing from each other. The two rotation axes are parallel to each other and perpendicular to a propagation direction of light 5 passing from the input optical system 10 to the filter selection mirror 30. Having regard to this propagation direction the light 5 is deflected on the filter selection mirror 30 via different polar angles onto the different optical paths 31 to 34.

In order to ensure that, in the plane of the drawing of FIG. 6, the light can additionally be deflected either to one of the left optical paths 31, 32 or to one of the right optical paths 33, 34, two azimuthal angles lying opposite each other can additionally be selected via the rotation of the filter selection mirror 30. In the case of a predefined polar angle range of the deflection of the light 5, a greater number of different optical paths 31 to 34 to different filters 11 to 14 can hereby be provided.

In contrast, in the embodiments of FIGS. 1 to 5 the polar angle, by which light 5 is deflected on the filter selection mirror 30, is equal for different optical paths 31, 32. The selection of an optical path 31, 32 is consequently realized solely through different azimuthal angles.

In FIG. 6 each of the optical paths 31 to 34 is in turn formed by two respective stationary deflection optical systems 41 to 44, 61 to 64. The light 5 passes between the two deflection optical systems of an optical path parallel to a connecting straight line 75 which connects the central regions of the filter selection mirror 30 and the output mirror 28 to each other. The filters 11 to 14 can in turn thereby be held in a mechanically simple way in a plane, in particular along a straight line.

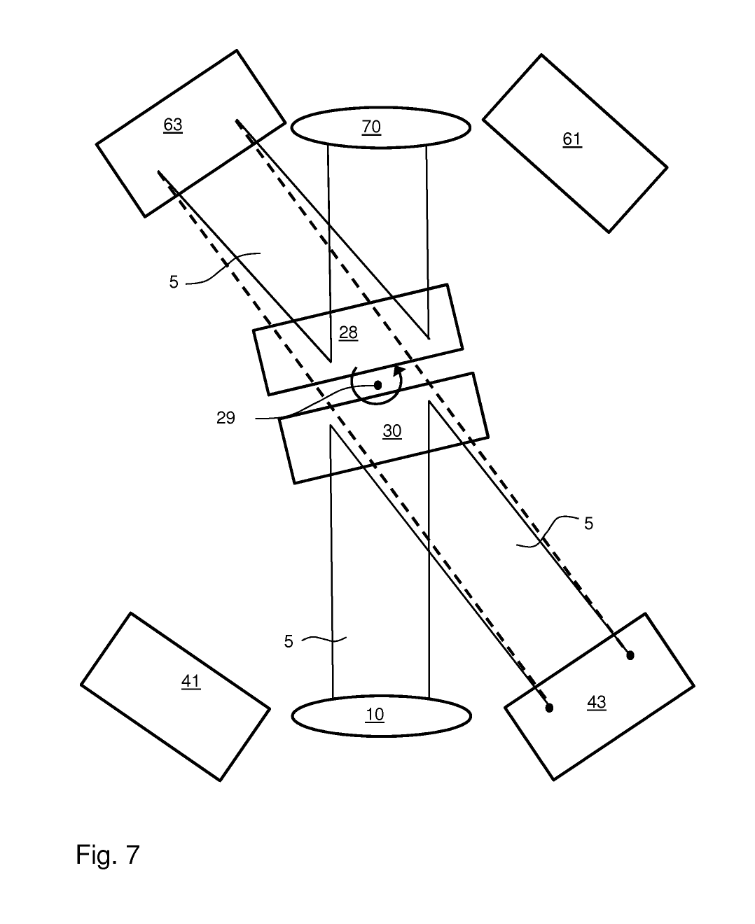

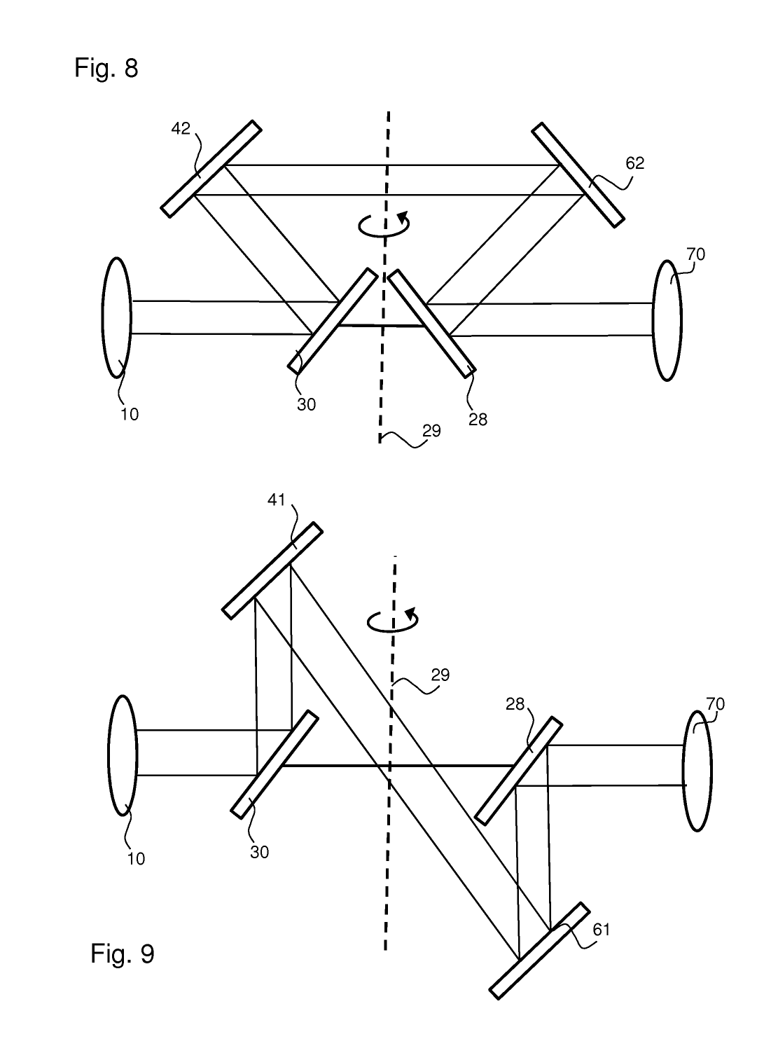

Components of a further embodiment of a light microscope according to the invention having an optical assembly according to the invention are shown in FIG. 7 in a top view and in FIG. 8 in a side view.

Here, the filter selection mirror 30 and the output mirror 28 are arranged lying opposite each other with respect to the common rotation axis 29. The surface normals of the two mirrors 30, 28 are constantly at a polar angle to the rotation axis 29 which is equal for both mirrors 28, 30. Having regard to the rotation axis 29, an azimuthal angle between the mirrors 28, 30 is preferably 180°.

In the position shown in FIG. 7, light 5 is deflected from the filter selection mirror 30 to a first deflection optical system 43. From there, the light 5 passes along the dashed lines to a second deflection optical system 63 and further to the output mirror. The first and second deflection optical systems 41 to 43, 61 to 63 are arranged in the direction of the rotation axis 29 offset with respect to the mirrors 28, 30, as can be seen from FIG. 8. The first and second deflection optical systems 41 to 43 and 61 to 63 may be arranged in a plane extending perpendicular to the rotation axis 29 and spaced apart from the mirrors 28 and 30. In order to allow a better overview, the filters are not shown in FIGS. 7 and 8.

A further embodiment of the invention is shown schematically in a side view in FIG. 9. In contrast with FIG. 8, the mirror surfaces of the two mirrors 28 and 30 are parallel to each other here. Their surface normals are thereby straight with opposing orientation, that is to say anti-parallel.

It follows from this that the first deflection optical systems are spaced apart from the mirrors 28, 30 in a first direction along the rotation axis 29. In FIG. 9, the first deflection optical system 41 is above the mirrors 28, 30. The second deflection optical systems are spaced apart from the mirrors 28, 30 in an opposite direction along the rotation axis 29. Accordingly the second deflection optical system 61 in FIG. 9 is located below the mirrors 28, 30.

Very short switching times can be achieved with the light microscope 110 according to the invention and the optical assembly 100 according to the invention through the two rotatable mirrors 30, 28. The optical path lengths of the optical paths, hereby used, to different filters 11 to 22 are equal due to the arrangement of separate deflection optical systems. Advantageously, imaging differences between the different optical paths are hereby minimized. If the light is guided as a parallel beam bundle between the two mirrors 30, 28, the effects of minimal remaining differences in the optical path lengths can be further reduced. A particularly low likelihood of errors in the rotation of the two mirrors 30, 28 is achieved, finally, if the two mirrors 30 and 28 are mounted so that they can rotate around a common rotation axis 29.

1. Optical assembly for spectral filtration of light, comprising:
a plurality of filters which are permeable to light of different spectral ranges;
a filter selection mirror which can be moved for selectable deflection of light to different optical paths to the different filters; and
an output mirror which can be moved for guiding light coming from one of the filters to an optical path which is the same for all filters,
wherein
in each case at least one stationary deflection optical system for guiding at least one of light from the filter selection mirror to the respective filter and light from the respective filter to the output mirror is provided for each of the optical paths to the different filters and
the stationary deflection optical systems are arranged so that optical path lengths on the different optical paths from the filter selection mirror to the output mirror are equal.

2. Optical assembly according to claim 1,
wherein
an input optical system is provided in the optical path in front of the filter selection mirror to guide incident light as a parallel beam bundle to the filter selection mirror.

3. Optical assembly according to claim 1,
wherein
at least one of the filter selection mirror, the output mirror and the deflection optical systems each have a planar light contact surface.

4. Optical assembly according to claim 1,
wherein
precisely one stationary deflection optical system is arranged in each of the optical paths to different filters, and
the deflection optical systems are arranged so that the optical path lengths from the filter selection mirror to the deflection optical systems are equal in order to reduce imaging differences between the different optical paths.

5. Optical assembly according to claim 1,
wherein
in each case a first and a second stationary deflection optical system are arranged in each of the optical paths to different filters, wherein light can be guided from the filter selection mirror via one of the first deflection optical systems to the associated filter and further via the associated second deflection optical system to the output mirror.

6. Optical assembly according to claim 1,
wherein
the filter selection mirror and the output mirror are mounted so that they can rotate around a common rotation axis which is located in or parallel to an optical axis of light passing to the filter selection mirror.

7. Optical assembly according to claim 6,
wherein
the filter selection mirror and the output mirror are rigidly connected to each other and a common drive shaft is provided to rotate both the filter selection mirror and also the output mirror.

8. Optical assembly according to claim 6,
wherein
the filter selection mirror and the output mirror are rigidly connected to each other,
a common drive shaft is provided to rotate both the filter selection mirror and also the output mirror and
a filter holder is provided to hold the filters in a plane extending perpendicular to the common drive shaft of the filter selection mirror and the output mirror.

9. Optical assembly according to claim 6,
wherein
the filter selection mirror and the output mirror are rigidly connected to each other,
a common drive shaft is provided to rotate both the filter selection mirror and also the output mirror,
a filter holder is provided to hold the filters in a plane extending perpendicular to the common drive shaft of the filter selection mirror and the output mirror, and
the filter holder has an opening in the middle, through which the drive shaft of the filter selection mirror and the output mirror extends.

10. Optical assembly according to claim 1,
wherein
the filter selection mirror and the output mirror are mounted so that they can rotate around rotation axes differing from each other and
the rotation axes of the filter selection mirror and the output mirror are respectively transverse, in particular perpendicular, to a propagation direction of light passing to the filter selection mirror.

11. Optical assembly according to claim 1,
wherein
the filters are arranged mirror symmetrically or rotationally symmetrically to a connecting straight line between a central region of the filter selection mirror and a central region of the output mirror in order to provide equal optical path lengths on the different optical paths.

12. Optical assembly according to claim 1,
wherein
additional filters for selecting further spectral ranges are provided and motorized filter changers are provided and adapted to move a respective one of the additional filters into one of the optical paths to one of the filters and out again.

13. Optical assembly according to claim 1,
wherein
at least one of the filters is a graduated filter, over the length of which a spectral transmission range changes, and
electronic control means are provided and adapted to move the graduated filter in order to select a certain spectral transmission range of the graduated filter.

14. Optical assembly according to claim 1,
wherein
a plurality of the filters are graduated filters,
electronic control means are provided and adapted to respectively record two consecutive specimen images with different graduated filters and, for the purpose of reducing a measurement interruption time, to move one of the graduated filters while a specimen image recording is realized with another one of the graduated filters.

15. Optical assembly according to claim 1,
wherein
at least one camera is arranged to measure the light in the optical path behind the output mirror and
electronic control means are provided and adapted to carry out an adjustment of the filter selection mirror and the output mirror during a readout time of the at least one camera in order to change between the different optical paths to the different filters.

16. Optical assembly according to claim 1,
wherein
a plurality of cameras are provided in the optical path behind the output mirror,
at least one color splitter is provided between the output mirror and the cameras, with which color splitter the light is further guided to one of the cameras in dependence upon the wavelength,
electronic control means are provided and adapted, for the purpose of recording a plurality of specimen images with light of different spectral ranges, to adjust the filter selection mirror and the output mirror for sequential selection of different filters, and, for the purpose of reducing a measurement interruption time, the electronic control means are adapted to consecutively select such filters as those, in which the light is guided to different cameras due to the transmission ranges of these filters on the color splitter.

17. Light microscope
having a light source to illuminate a specimen,
wherein
an optical assembly according to claim 1 is provided for spectral filtration of light coming from the specimen.

18. Light microscope according to claim 17,
wherein
imaging means are provided to produce an imaging of the specimen in an intermediate image plane and
the input optical system is arranged so that it produces an imaging of this intermediate image plane at infinity.
